(19) United States
(12) Patent Application Publication
(10) Pub. No.: US 2023/0356987 A1
(43) Pub. Date: Nov. 9, 2023

(54) Retrofit System and Method for Maintaining Minimum Approach Distance

(71) Applicant: QUANTA ASSOCIATES, L.P., Houston, TX (US)

(72) Inventors: Robert Wayne Palmer, Houston, TX (US); Randolph Bolton Cassidy, Prairieville, LA (US); Jonathan Breaux Pipsair, Prairieville, LA (US); Christopher James Snapp, Prairieville, LA (US); Derek Michael Helmke, Prairieville, LA (US); Peter Raymond McKay, JR., La Grange, TX (US); Trevor Stanley Johnson, La Grange, TX (US)

(21) Appl. No.: 18/312,460

(22) Filed: May 4, 2023

Related U.S. Application Data
(60) Provisional application No. 63/338,522, filed on May 5, 2022.

(30) Foreign Application Priority Data
May 5, 2022 (CA) 3157744

(51) Int. Cl. B66C 23/88

(52) U.S. Cl. CPC B66C 23/88

(57) ABSTRACT

A system for visually maintaining a predetermined minimum approach distance between load handling equipment and energized electrical equipment includes at least two elongate electrically insulating members that have lengths that correspond to the predetermined minimum approach distance that are mounted to at least a distal end of the load handling equipment so that they extend orthogonally outwardly from the distal end by substantially the predetermined minimum approach distance. One of the insulating members is rotatably mounted using a counterweight so as to be vertical, independent of the orientation of the load handling equipment. In use, when the distal end is in the vicinity of the energized electrical equipment, the insulating members provide visual indication that the predetermined minimum approach is being maintained and is not being encroached. A corresponding method is also described.

### FIELD

Embodiments described herein generally relate to a system for use with load handling equipment used in the servicing or replacing of energized, high voltage electrical equipment. More particularly, embodiments described herein relate to a system which enables a predetermined minimum clearance to be maintained between the load handling equipment and the energized electrical equipment during the servicing or replacing operation. A corresponding method is also disclosed.

### BACKGROUND

Live-line working or hot-line maintenance is the maintenance of electrical equipment such as conductors, often operating at high voltages, while the equipment is energized. Live-line work also includes maintenance or repair work on support towers or poles suspending the energized conductors at a height in an overhead position. Maintenance or repair work to the poles may include replacement of old poles or new pole installations. Live-line working is more efficient because the electrical equipment does not need to be shut off while the maintenance is being performed on the electrical equipment or the towers or poles supporting them.

As stated above, the conductors, typically uninsulated conductors, are suspended at a height by support towers or poles. In order to work on the suspended energized conductors or the towers or poles suspending them at a height, load handling equipment such as a crane is generally used. If linemen are required to also work on the energized conductors, a bucket truck is used to position the linemen adjacent the energized conductors. Once the crane has been transported to the work site, the boom of the crane is then positioned by the crane operator to, for example, lift the energized conductors or the pole safely up and away from other energized electrical equipment. The boom of the crane is generally made of metal or of other material which must be treated as being electrically conductive. Consequently, any contact between the boom and the energized conductors during manipulation of the boom may result in high voltage current flowing through the crane. This in turn can cause one or more of electrocution, fire, and damage to the crane and other equipment at the work site, and electrocution or other injury to the crane operator and workers in proximity to the crane. FIG. 1 diagrammatically illustrates the flow of electric current through a crane due to contact at a work site between a crane boom and suspended energized conductors. Another scenario in which the contact described above is possible are new pole installations, especially when new poles are being installed in the vicinity of suspended energized conductors. During new pole installations, new poles are either driven into the ground through the use of a vibratory hammer or a new hole is drilled in the ground and the pole is then installed in the new hole via a crane. The crane lifts the new pole and suspends the pole over the new hole which has been drilled. Again, any contact between the crane or the new pole tethered to the crane and the suspended energized conductors, during manipulation of the crane, may result in high voltage current flowing through the crane. Even though the new poles are not connected to energized conductors during their setting, they are still inherently at least partially conductive due to induced electric fields generated by the energized conductors in the vicinity. Further, the new poles may become more conductive if they are wet or dirty.

Studies conducted by the Occupational Safety and Health Administration (OSHA) have shown that a significant percentage of work site electrocutions involved cranes accidentally contacting energized conductors. In order to address this issue, current OSHA regulations for live-line working require that a minimum clearance distance or minimum approach distance (MAD) be maintained between the energized electrical equipment and other equipment and work site personnel at all times. The minimum approach distance varies and depends upon the voltages of the conductors at the work site.

Typically, a worker at the work site is designated as a signaler to observe the clearance between the crane and the energized conductors and to warn the crane operator when any part of the crane, including its load, appears to be encroaching on or breaching the minimum approach distance. In some situations, the observation function is performed by the crane operator. As will be appreciated by those skilled in the art, this observation method relies on the attentiveness and judgement of the signaler or crane operator to actively judge when a minimum approach distance is being encroached by any part of the crane, and on the continuous active participation and heightened awareness of the signaler or crane operator. Poor viewing positions, weather conditions and distractions at the work site can impact the signaler or crane operator's judgement. Further, the minimum approach distance can change during the operation at the work site. For example, wind may cause the conductors to sway laterally or undulate vertically, or both, and thereby reduce the clearance between the crane and the conductors. These dynamic changes to the minimum approach distance may make correct judgement of the minimum approach distance difficult for the signaler or crane operator.

There is consequently a need for a system and method whereby minimum approach distance can be maintained at a work site in an improved and inexpensive manner and which does not rely entirely on the judgement of a signaler or crane operator, and which system may be retrofitted to equipment at the work site.

### SUMMARY

Accordingly, in one embodiment a system for use with a load handling equipment for maintaining a preset minimum approach distance between the load handling equipment and energized electrical equipment at a work site is provided. The system may or may not be for retrofit to the load handling equipment, as it may also be provided as part of the load handling equipment. The system comprises a base member which has at least first and second couplings mounted thereon. The first base member is adapted to be removably mounted to an end of the load handling equipment. The system further comprises first and second elongate electrically insulating members which are adapted to be removably mounted to the first and second couplings, respectively. The first and second insulating members have lengths that correspond to the preset minimum approach distance, and when they are mounted to the base member via the first and second couplings the first and second insulating members extend outwardly from the base member in first and second orthogonal directions, respectively by the preset minimum approach distance. The first coupling is a free rotation coupling so that the first insulating member is rotatably mounted on the base member when mounted to the first coupling. The system also comprises a weight-countering member which is also removably mounted to the first coupling. The weight-countering member, when mounted to the base member, is in an oppositely disposed relation to the first insulating member when the first insulating member is mounted to the first coupling.

A rotational moment of the weight-countering member is greater than a rotational moment of the first insulating member about the first coupling so as to urge the first insulating member to a vertical orientation when the base member is mounted to the end of the load handling equipment. The first orthogonal direction is thus vertical. The second orthogonal direction is orthogonal to the end of the load handling equipment when the base member is mounted to the end of the load handling equipment. In use, when the base member, with the first and second insulating members and the weight-countering member mounted thereto, is mounted to the end of the load handling equipment, and the end of the load handling equipment is in proximity of the energized electrical equipment, the first and second insulating members extending outwardly from the base member by the preset minimum approach distance indicate the minimum approach distance between the end of the load handling equipment and the energized electrical equipment and thereby any encroachment upon the minimum approach distance.

Accordingly, in another embodiment a method, using the system described above, for maintaining a preset minimum approach distance between a load handling equipment and energized electrical equipment at a work site is provided. The method comprises removably mounting the base member to the end of the load handling equipment. The method further comprises removably mounting the weight-countering member and the first and second insulating members to the base member. Further, the method comprises manipulating the end of the load handling equipment and locating the end in the proximity of the energized electrical equipment. During the manipulation and location, the first and second insulating members extending outwardly from the base member by the preset minimum approach distance are used to visually detect whether the minimum approach distance is being maintained between the end of the load handling equipment and the energized electrical equipment and is not being encroached.

### BRIEF DESCRIPTION OF THE DRAWINGS

FIG. 1 is a diagrammatic illustration of a work site accident due to contact between the boom of a crane and suspended energized conductors, further illustrating an example of the travel of electric current through the crane during the contact;

FIG. 2 is a perspective view of one embodiment of the system described herein;

FIG. 3 is a top perspective view of one side of a first base member of the system of FIG. 2;

FIG. 4 is a perspective view of a pull magnet of the system of FIG. 2;

FIG. 5 is a perspective view of one of the elongate insulating members of the system of FIG. 2;

FIG. 6 is a front view of an elongate counterweight of the system of FIG. 2;

FIG. 7 is a top perspective view of a second base member of the system of FIG. 2;

FIG. 8 is a front view of the second base member of FIG. 7 with an elongate insulating member mounted thereon;

FIGS. 9A to 9E illustrate the various steps for removably mounting the system of FIG. 2 to a boom of a crane, wherein: FIG. 9A illustrates mounting of the first base member of FIG. 2 to a distal end of the boom, FIG. 9B illustrates mounting of the elongate counterweight of FIG. 6 to the first base member, FIG. 9C illustrates mounting of two elongate insulating members to the first base member of FIG. 2, FIG. 9D illustrates mounting of the second base member of FIG. 7 to a base end of the boom, and FIG. 9E illustrates mounting a third elongate insulating member to the second base member of FIG. 7;

FIGS. 10, 10A and 10B illustrate the system of FIG. 2 in use on the boom of a crane, FIGS. 10 and 10B are views looking from the side of the boom, and FIG. 10A is a view looking from the top of the boom;

FIG. 11 is a perspective view of another embodiment of the system described herein;

FIG. 12 is a perspective view of a coupling arrangement of the system of FIG. 11;

FIG. 13A is a front view of one embodiment of a base member of the system of FIG. 11;

FIG. 13B is a back view of the base member of FIG. 13A; and

FIG. 14 is a perspective view of another embodiment of the base member of the system of FIG. 11.

### DETAILED DESCRIPTION

Embodiments described herein relate to a system, which may be a retrofit system, which enables a preset minimum approach distance (MAD) to be maintained between load handling equipment such as a crane, and energized electrical equipment such as energized conductors at a work site during, for example, servicing or repair of the energized electrical equipment or the towers or poles suspending the energized conductors at a height in an overhead position at the work site. Thus, embodiments described herein depict and describe the energized electrical equipment as suspended energized power lines or conductors and the load handling equipment as a crane. However, a person skilled in the art will understand that the energized electrical equipment may include components other than conductors such as static lines, optical ground wires (OPGWs) or substation bus pipes and couplings or couplers associated with the lines, wires or pipes. Couplings may include, but are not limited to, compression sleeves which join ends of two conductors together or dead-ends or dead end connectors which are used to attach the conductors to support towers or poles.

The load handling equipment may be any equipment that is used at the work site for hoisting and moving energized electrical equipment or towers or poles suspending energized conductors at a height or enabling work on or with them. Load handling equipment may include, but not limited to, material handling cranes, hoists, bucket trucks, scissor lifts, jibs, digger trucks or forklifts.

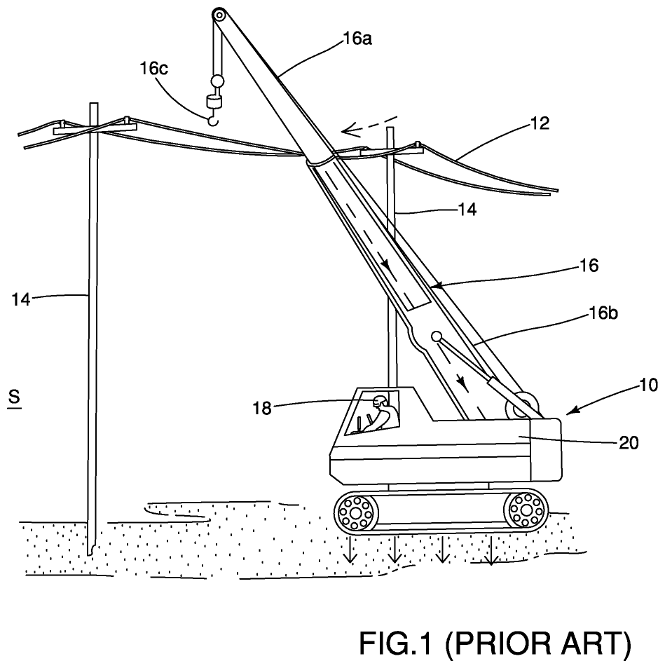

In one embodiment, and as illustrated in FIG. 1, a crane 10 is located at a work site S and is operating in the proximity of suspended energized conductors 12. The energized conductors 12 are suspended at a height by poles 14. The crane has a boom 16 which is operated to lift or manipulate the energized conductors 12 or the poles 14 through a load hoisting means including a hook 16c to which the energized conductors 12 or the poles 14 may be connected. In some applications, the boom 16 may be the boom on a bucket truck (not shown) to support and position a lineman (not shown) adjacent the suspended energized conductors 12 so that the lineman can perform work on, or service, the energized conductors 12. In FIG. 1, boom 16 is operated by an operator 18 located in truck 20 of the crane. The boom 16 is metallic and has an upper or distal end 16a and a lower or base end 16b. The base end 16b is mounted on truck 20 and the distal end 16a and the hook 16c, in an elevated-for-use position, is located in the vicinity of energized conductors 12.

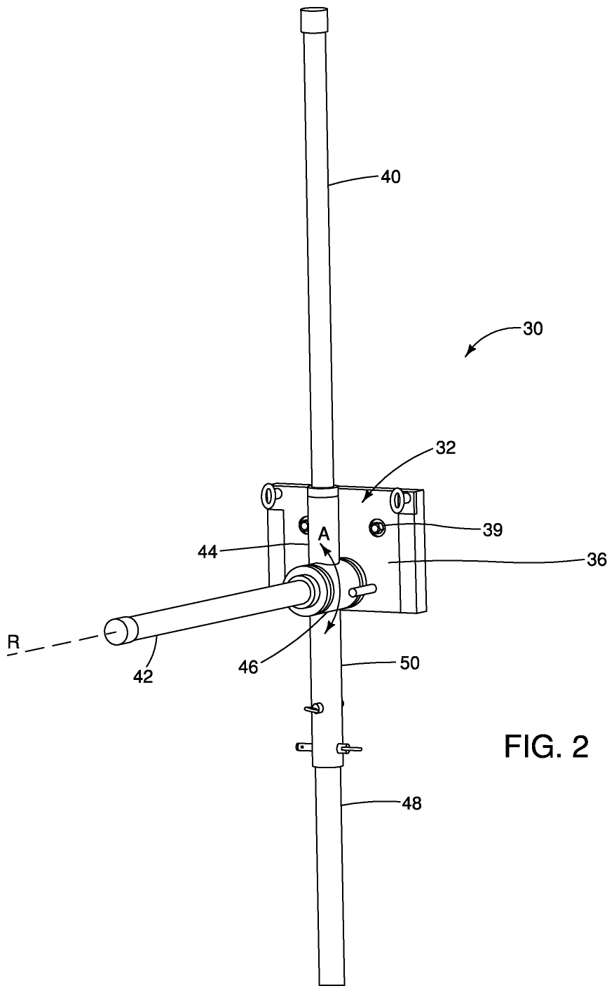

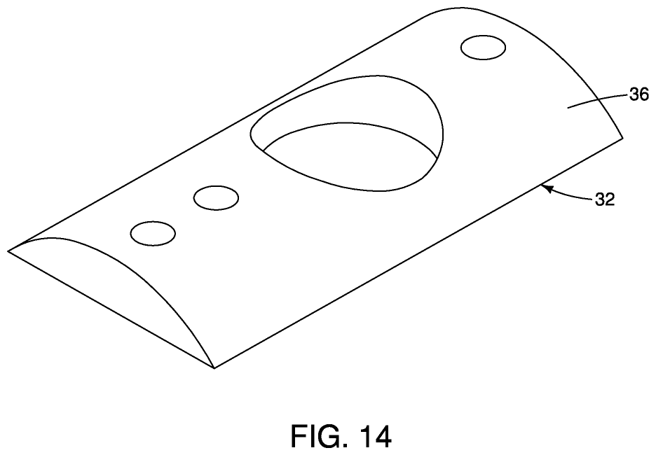

The minimum approach tool of system 30, described and illustrated in several embodiments herein, which are not intended to be limiting, may be used to maintain a minimum approach distance between the energized conductors 12 and boom 16 on crane 10. As discussed above, minimum approach distance varies and is dependent on the voltage of the energized conductors 12. FIG. 2 illustrates one embodiment of system 30. System 30 includes a first base member 32 having a first side 34 which is attached to the boom, and a second side 36 which faces away from the boom. The first base member 32, in use, is removably mounted to the distal end 16a of boom 16. Two embodiments of the first base member are illustrated by way of example. FIGS. 1 to 13B illustrate a flat plate embodiment of base member 32. FIG. 14 illustrates curved outer surface embodiment of the base member. As will be described in detail below, in the embodiments of FIGS. 1 to 13B, the base member 32 is removably mounted to the distal end of the boom by a magnet assembly. In the embodiment of FIG. 14, the base member is removably mounted to the distal end of the boom by a fastener assembly, which may include, for example, nuts and bolts, pins, or threaded screws.

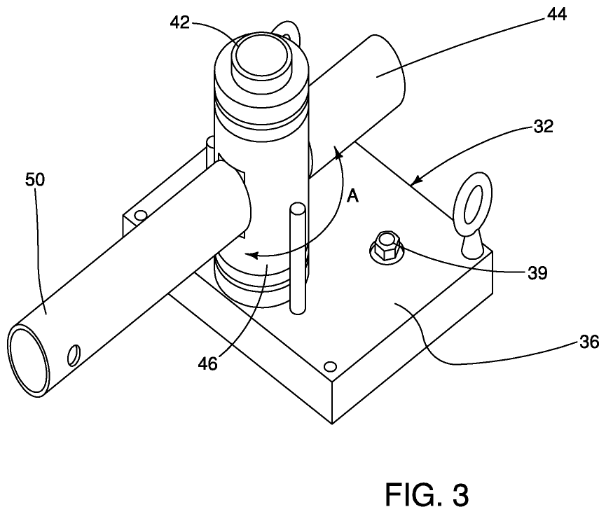

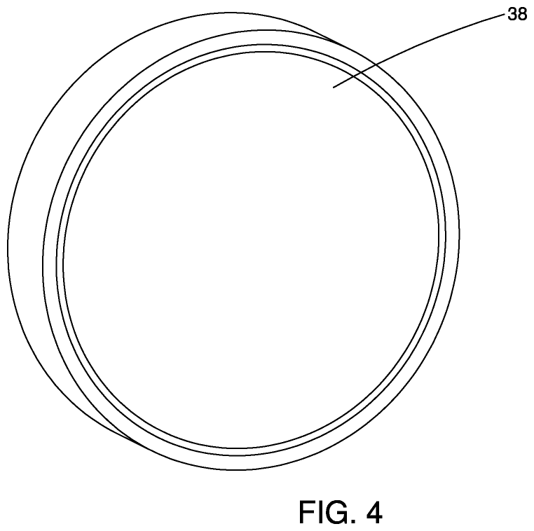

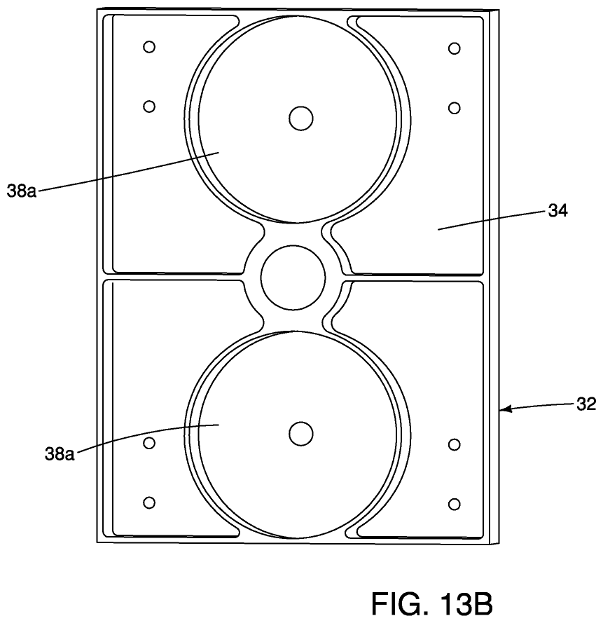

Continuing with the embodiments of FIGS. 1 to 13B, the first side 34 of base member 32, best seen in FIG. 13B, includes a magnet assembly attached thereto for magnetic mounting of the first base member 32 to boom 16. In one embodiment, the magnet assembly includes one or more pull magnets 38 located in corresponding magnet holders such as cavities 38a within circular flanges in the first side 34 of the base member 32. An example of a pull magnet 38 is illustrated in FIG. 4. In the embodiment of FIG. 14, as stated above, the first base member 32 is removably mounted through a fastener assembly 39, which may include removable pins, or nuts and bolts, such as, for example, the nuts or bolts illustrated in FIGS. 2 and 3 or threaded screws.

Magnetic coupling or coupling through a fastener assembly allows the system 30 to be releasably mounted to boom 16.

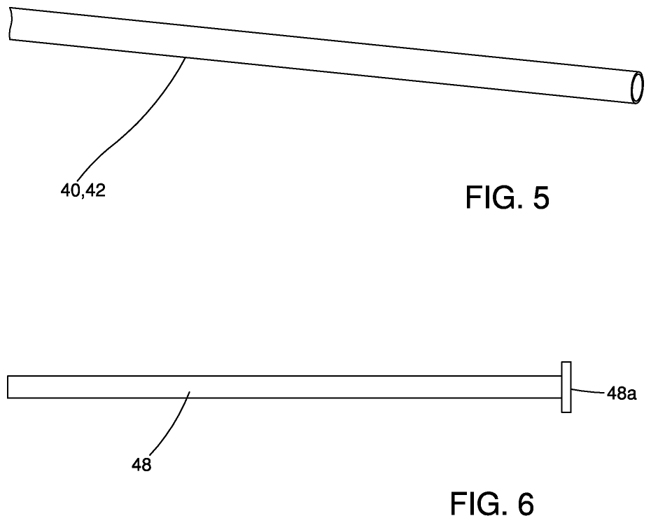

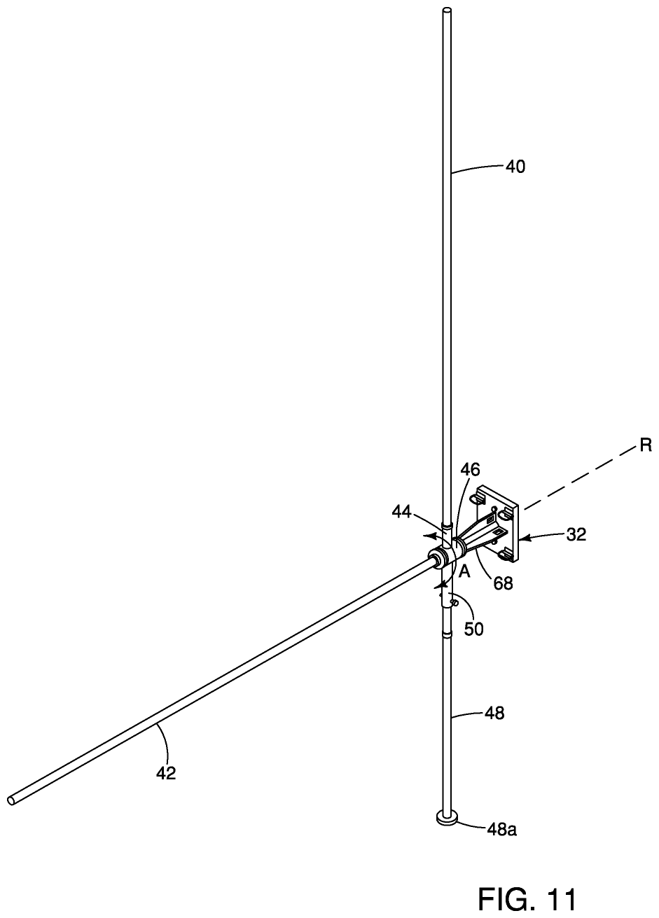

With respect to FIG. 2, system 30 further includes two elongate dielectric or electrically insulating members 40 and 42, illustrated by way of example as slender rods, and a counterweight arm 48, also illustrated by way of example as a slender rod. The rods and the counterweight arm are removably mounted to the second side 36 of the base member 32 via rotary bearing housing 46. In one embodiment, the two insulating members 40 and 42 are fiber glass rods. One end of one such rod is illustrated in FIG. 5. As better seen in FIG. 11, rotary bearing housing 46 allows the insulating member 42 to rotate in direction A about the axis of rotation R relative to the base member 32. Receptacles or collars 44 and 50 are mounted to, so as to extend from, the rotary bearing housing 46. Collars 44 and 50 receive and releasably retain the base ends of the insulating member 40 and counterweight arm 48 respectively such that they are co-linearly aligned and oppositely disposed on opposite sides of rotary bearing housing 46. The base end of insulating member 42 mounts into a hole 46a located in the rotary bearing housing 46. The base end of insulating member 42 may extend through the full length of rotary bearing housing 46. Insulating member 42 lies on the axis of rotation R of the rotary bearing housing 46 when mounted in the rotary bearing housing 46. Insulating member 42 extends orthogonally to insulating member 40 and counterweight arm 48.

Lengths of the two insulating members 40 and 42 correspond to the preset MAD. The preset MAD and the corresponding lengths of the two insulating members 40 and 42 will vary depending on the application. Counterweight 48a is mounted, for example removably mounted to the distal end of counterweight arm 48. In one embodiment the counterweight 48a mounted on the distal end of counterweight arm 48 is selectively positionable along the distal end of counterweight arm 48. Counterweight arm 48 may be an elongate rod, which may also be a dielectric rod. The base end of counterweight arm 48 is releasably mounted in collar 50. In this embodiment, the weight of the counterweight 48a on counterweight arm 48 is dependent on the length and weight of the first insulating member 40. Thus, primarily the density and length of first insulating member 40 will determine the moment of insulating member 40 sought to be countered or resisted by the counterweight 48a on counterweight arm 48. The counterweight 48a on counterweight arm 48 thus resists rotation of the insulating member 40 about the axis of rotation R of rotary bearing housing 46 to thereby maintain the desired vertical orientation of the insulating member 40.

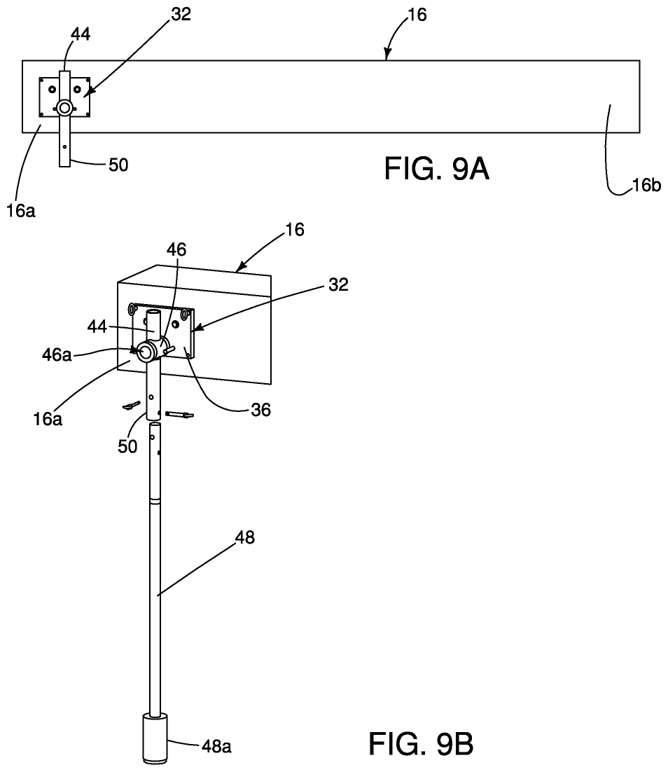

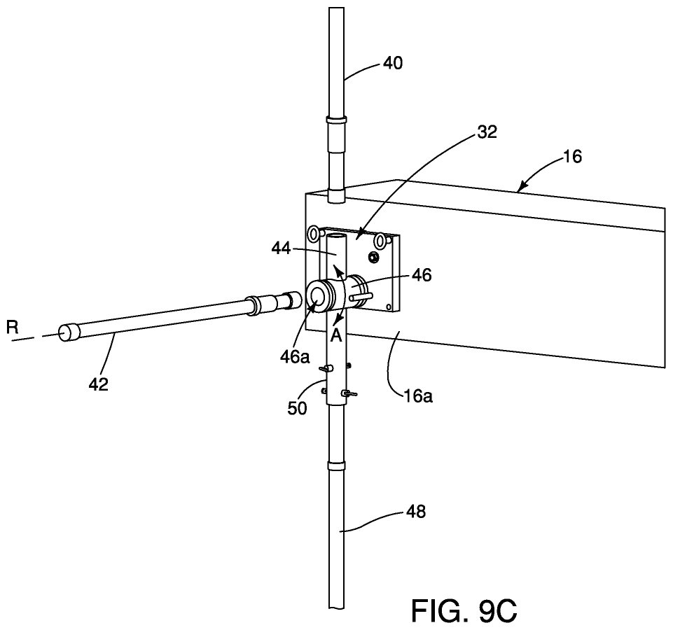

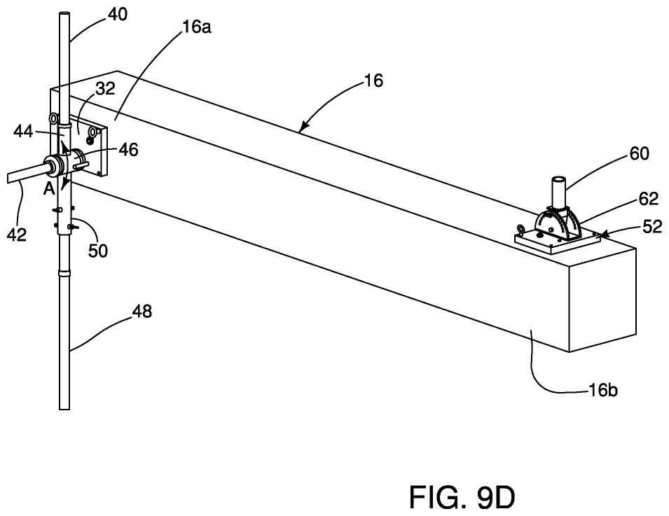

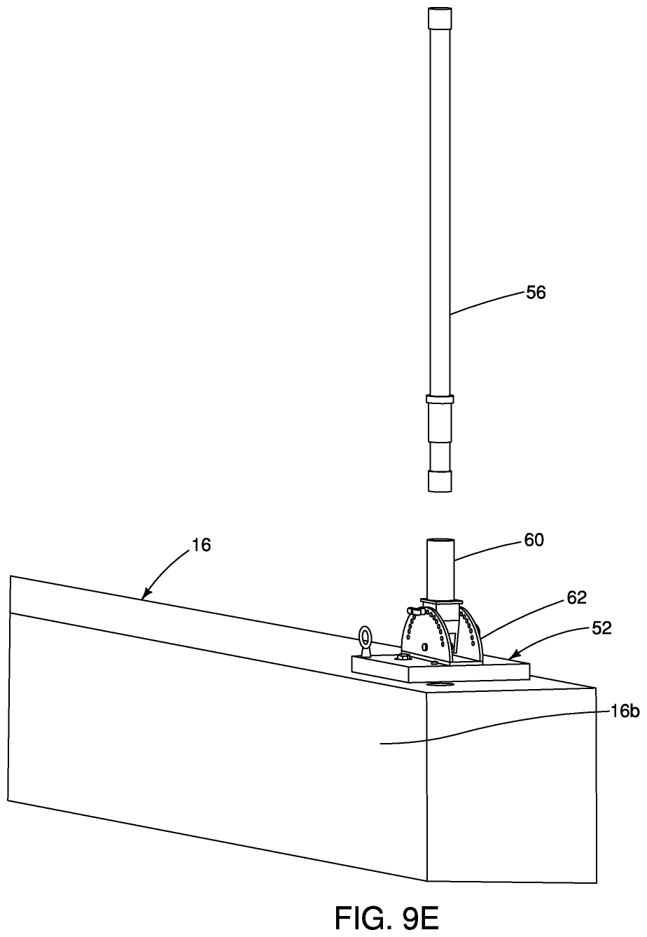

During use, in one embodiment, the first base member 32 is removably mounted to a side of the boom 16 at the distal end 16a to boom 16. The counterweight arm 48 and the insulating members 40 and 42 are then mounted to the first base member 32 (FIGS. 9B and 9C). The insulating members 40 and 42, once mounted, extend outwardly from the first base member 32, perpendicular to one another. Insulating member 42 extends in a horizontal direction. Insulating member 40 extends in a vertical direction. Thus, the distal ends of insulating members 40 and 42 are located orthogonally distal from the base 32 by the preset MAD. The lineman assembling the minimum approach tool of system 30 will determine the appropriate MAD for the job and will select and install insulating members 40 and 42 whose lengths correspond to the appropriate MAD. The lineman will also select the appropriate counterweight 48a for mounting onto counterweight arm 48. Preferably, system 30 would include a selection of different lengths of insulating members 40 and 42, or possibly the insulating members may be modular or telescopic. The system may also provide corresponding counterweights 48a for the lineman to choose from. The insulating members may be brightly colored so as to stand out against a background illuminated by bright sun or so as to stand out on a dull grey day, or may otherwise be colored or possibly illuminated, for example at the distal ends of the insulating members, for ease of viewing from the ground so that encroachment on the MAD may be more easily and quickly visually detected.

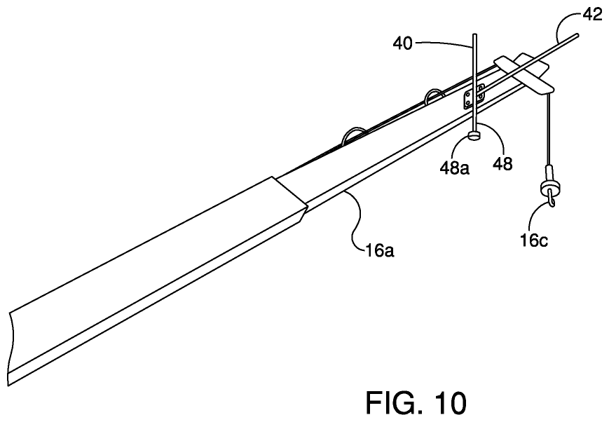

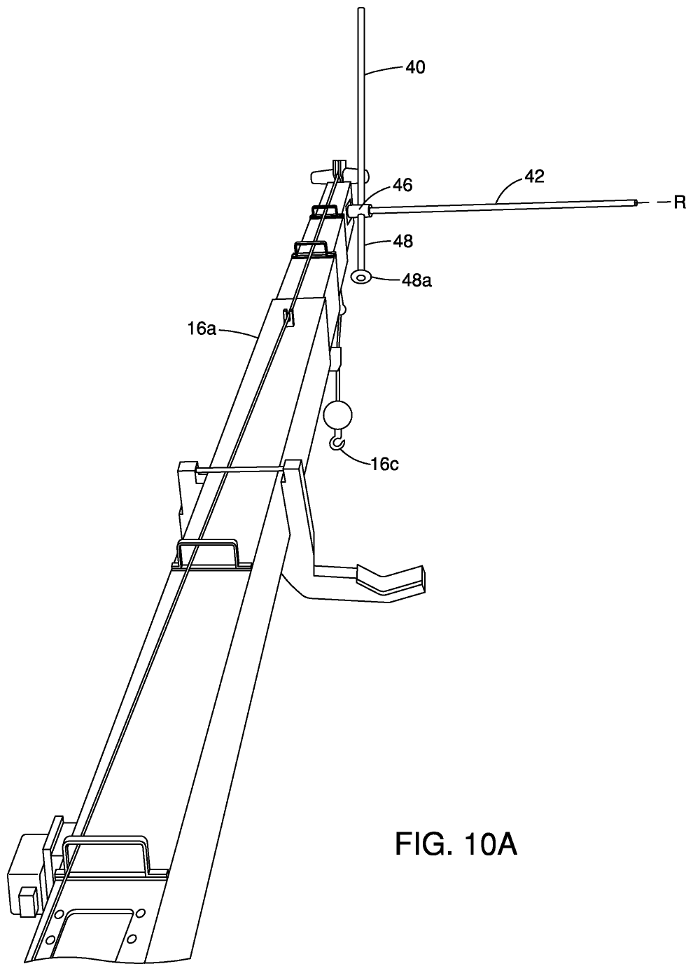

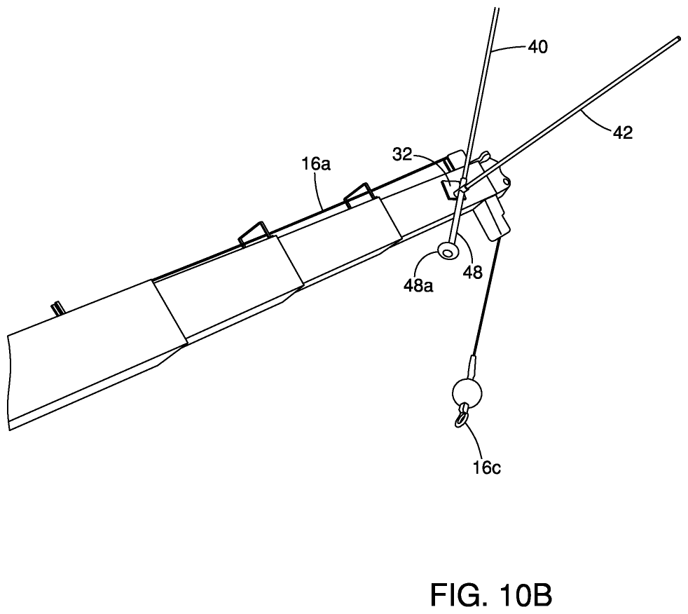

In use, and with reference to FIGS. 10, 10A and 10B, when the distal end 16a boom is positioned in proximity to the suspended energized conductors 12, the insulating members 40 and 42 extending outwardly from the first base member 32 by the preset MAD provide spatial indication to the operator 18 and to other workers, such as spotters/signalers, assisting the operator, so that the operator 18 may maintain the appropriate MAD spacing between the suspended energized conductors 12 and the distal end 16a. System 30 thus assists the operator 18 in ensuring that the MAD is maintained between the crane 10, and in particular the upper end of boom 16, and the suspended energized conductors 12. In the event of inadvertent contact of the end of either insulating member 40 or 42 with an energized conductor, the insulating properties of the insulating members will prevent transmission of electric current to the boom.

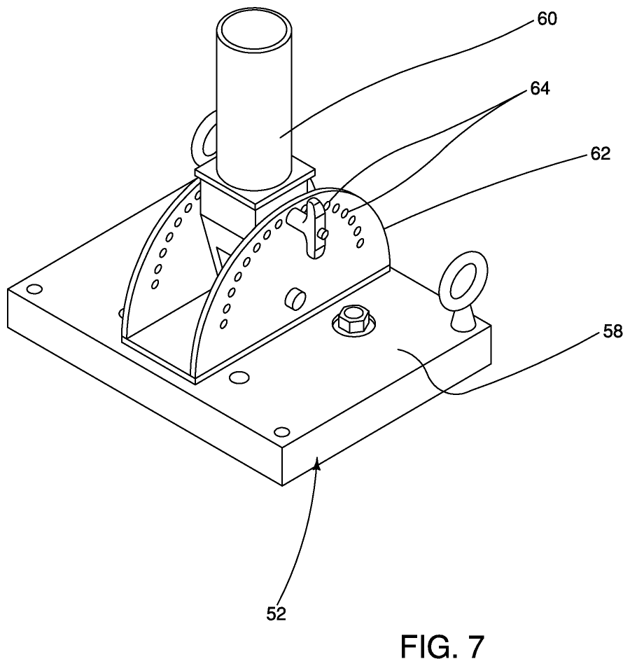

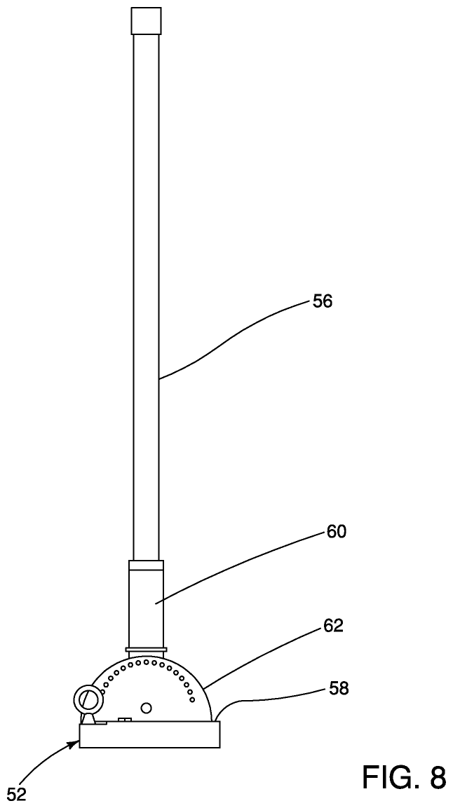

In one embodiment and with reference to FIGS. 7, 8, 9D and 9E, when the crane 10 is located adjacent another crane (not shown) at the work site S or between two rows of suspended energized conductors 12, the system 30 includes a further base member and associated insulating member(s) such as fiberglass rod(s) which assist in maintaining the minimum approach distance between the base end 16b of the boom 16 and other equipment in the vicinity of the base end 16b. In this embodiment and with reference to FIGS. 7 and 8, the system 30 thus also includes a second base member 52 which is adapted to be removably mounted to the base end 16b of the boom 16 (FIG. 9D). Mounting may be via the fastener or magnet assembly described above. With respect to FIG. 8, the system 30 thus also further includes a third insulating member 56 which is adapted to be mounted to a second side 58 of the second base member 52. The second side 58 has a third receptacle 60 which is adapted to receive and rigidly retain therein the third insulating member 56 (FIG. 9E). The third insulating member 56 is similar in its dielectric properties to the first and second insulating members 40 and 42 discussed above. The length of the third insulating member 56 also corresponds to the preset MAD. When the third insulating member 56 is mounted to the second base member 52, the third insulating member 56 extends outwardly from the second base member 52 by substantially the preset MAD. In one embodiment and with reference to FIG. 7, the third receptacle 60 is operatively coupled to an angle-adjustable bracket 62 so as to adjust the orientation of the third receptacle 60 relative to the second base member 52. In some applications, the preferred orientation is mounting the third receptacle 60 and consequently the third insulating member 56 to be perpendicular to the base end 16b of the boom 16. To achieve the preferred orientation, an appropriate angle on the angle-adjustment bracket 62 is selected and the third receptacle 60 with the third insulating member 56 rigidly retained therein is locked at the selected angle by a pin and slot latching mechanism 64.

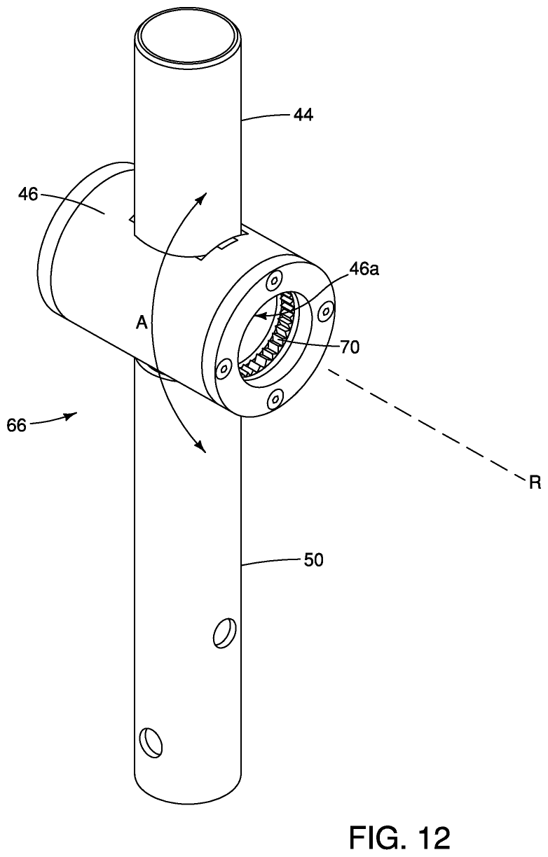

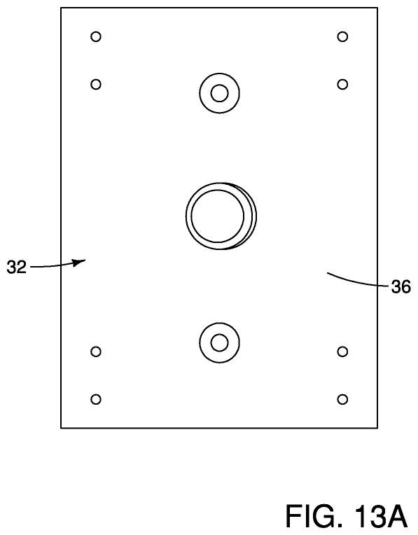

In one embodiment, the coupling arrangement 66 thus may include collars 44 and 50 and the collar formed in the end of the rotary bearing housing 46. The coupling arrangement 66 is best seen in FIG. 12. The coupling arrangement is directly fitted to the second side 36 of the base member 32, for example, as seen in FIG. 2, or is fitted to the second side 36 of the base member 32 through a stabilizing bracket assembly 68 as seen in FIG. 11. In one embodiment, the second insulating member 42 is rotationally and removably retained in second coupling 46 using bearing 70, FIG. 12.

After use, the system 30 may be detached or de-coupled from the boom 16 by a detachment rod (not shown).

Based on testing, correlation between the lengths of the insulating members 40 and 42 and the weight 48a on counterweight arm 48 may be as follows: 10 feet corresponds to 15 pounds, 5 feet corresponds to 12.5 pounds, and 3 feet corresponds to 10 pounds.

While the embodiments are described with reference to various implementations and exploitations, it will be understood that these embodiments are illustrative and that the scope of the inventive subject matter is not limited to them. Many variations, modifications, additions, and improvements are possible. Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A system for use with a load handling equipment for maintaining a preset minimum approach distance between a distal end of the load handling equipment and energized electrical equipment at a work site, the system comprising:
a first base member having at least first and second couplings, wherein the first base member is adapted to be removably mounted to the distal end of the load handling equipment;
first and second elongate electrically insulating members adapted to be removably mounted to the first and second couplings, respectively, the first and second insulating members having lengths that correspond to the preset minimum approach distance and, when mounted to the first base member, extend outwardly from the first base member in first and second orthogonal directions, respectively by the preset minimum approach distance, and wherein the first coupling is a free rotation coupling so that the first insulating member is freely rotatably mounted on the first base member when the first insulating member is mounted to the first coupling;
a weight-countering member adapted to be removably mounted to the first coupling which, when so mounted, is in an oppositely disposed relation to the first insulating member when the first insulating member is mounted to the first coupling, wherein a rotational moment of the weight-countering member is greater than a rotational moment of the first insulating member about the first coupling so as to continuously urge the first insulating member, extending in the first orthogonal direction, to a vertical orientation when the first base member is mounted to the distal end of the load handling equipment,
and wherein the second insulating member when mounted in the second coupling extends in the second orthogonal direction so as to be orthogonal to the distal end of the load handling equipment when the first base member is mounted to the distal end of the load handling equipment,
whereby, in use, when the first base member with the first and second insulating members and the weight-countering member mounted thereto is mounted to the distal end of the load handling equipment, and the distal end of the load handling equipment is in proximity of the energized electrical equipment, the first and second insulating members extending orthogonally outwardly from the first base member by the preset minimum approach distance provide a visual indicator of the minimum approach distance between the distal end of the load handling equipment and the energized electrical equipment and thereby any encroachment upon the minimum approach distance.

2. The system of claim 1, wherein the energized electrical equipment is suspended energized conductors, and the load handling equipment is a crane having a boom, and wherein the end of the load handling equipment is a distal end of a metal section of the boom.

3. The system of claim 2, wherein the first base member is removably mounted to the distal end by a fastener assembly.

4. The system of claim 2, wherein the first base member is removably mounted to the distal end by a magnet assembly.

5. The system of claim 1 wherein the first and second insulating members are dielectric rods.

6. The system of claim 1, wherein the first coupling includes first and second receptacles adapted to receive and retain therein the first electrically insulating member and the weight-countering member.

7. The system of claim 6, wherein the weight-countering member is a counterweight arm rod having a counterweight mounted thereon.

8. The system of claim 7, wherein the counterweight arm and the first insulating member are colinear when mounted to the first coupling.

9. The system of claim 1 wherein the first and second insulating members are contrastingly colored so as to contrastingly stand out against the work site and sky background.

10. The system of claim 1 wherein the first coupling includes a rotary coupling having oppositely disposed collars for mounting of the first insulating member and the counterweight arm thereto.

11. The system of claim 2, further comprising:
a second base member adapted to be removably mounted to a base end of the metal section of the boom; and
a third elongate electrically insulating member adapted to be removably mounted to the second base member, the third insulating member having a length that corresponds to the preset minimum approach distance and, when mounted to the second base member, extends outwardly from the second base member by the preset minimum approach distance.

12. The system of claim 11, wherein the third insulating member is mounted to an angle-adjustable bracket on the second base member so as to selectively adjust an orientation of the third insulating member relative to the second base member.

13. The system of claim 11, wherein the third insulating member is a dielectric rod.

14. A method, using the system of claim 1, for maintaining a preset minimum approach distance between a load handling equipment and energized electrical equipment at a work site, the method comprising:
removably mounting the first base member to the end of the load handling equipment;
removably mounting the weight-countering member to the first coupling;
removably mounting the first and second insulating members to the first and second couplings respectively;
manipulating the end of the load handling equipment and locating the end in the proximity of the energized electrical equipment; and
during the manipulation and location, using the first and second insulating members extending outwardly from the first base member by the preset minimum approach distance to visually detect whether the minimum approach distance is being maintained between the end of the load handling equipment and the energized electrical equipment and is not being encroached.

15. The method of claim 14, wherein the energized electrical equipment is suspended energized conductors, and the load handling equipment is a crane having a boom, and wherein the end of the load handling equipment is a distal end of a metal section of the boom, and wherein the step of removably mounting the first base member comprises mounting the first base member to the distal end of the metal section.

16. The method of claim 14, wherein the step of removably mounting the first base member comprises mounting the first base member to the end of the load handling equipment by a fastener assembly.

17. The method of claim 14, wherein the step of removably mounting the first base member comprises mounting the first base member to the end of the load handling equipment by a magnet assembly.

18. The method of claim 15 further comprising:
removably mounting a second base member to a base end of the metal section of the boom, wherein the base end is proximal to a truck of the crane; and
removably mounting a third elongate electrically insulating member, having a length that corresponds to the preset minimum distance, to the second base member so that the third insulating member extends outwardly from the second base member by the preset minimum approach distance; and
using the third insulating member extending outwardly from the second base member by the preset minimum approach distance to visually detect whether the minimum approach distance is being maintained between the base end and the energized electrical equipment and is not being encroached.
